(19) United States
(12) Patent Application Publication
(10) Pub. No.: US 2012/0218171 A1
(43) Pub. Date: Aug. 30, 2012

(54) HEAD-MOUNTED DISPLAY AND CLIENT APPARATUS

(75) Inventor: Hayato FUJIGAKI, Tokyo (JP)

(73) Assignee: OLYMPUS CORPORATION, Tokyo (JP)

(21) Appl. No.: 13/405,626

(22) Filed: Feb. 27, 2012

(30) Foreign Application Priority Data
Feb. 28, 2011 (JP) 2011-041314

(51) Int. Cl. G06F 15/16; G09G 5/00

(52) U.S. Cl. 345/8; 709/219

(57) ABSTRACT

A head-mounted display includes a display section that displays a display image, a communication section that communicates with a client apparatus and an external server system, and a processing section, the communication section receiving an HTTP request when the client apparatus has displayed an operation screen on a display section of the client apparatus, and transmitted the HTTP request to the head-mounted display based on an operation performed using the operation screen, the processing section executing a command that corresponds to the HTTP request, and the communication section transmitting an execution result of the command to the client apparatus as an HTTP response.

Japanese Patent Application No. 2011-041314 filed on Feb. 28, 2011, is hereby incorporated by reference in its entirety.

### BACKGROUND

The present invention relates to a head-mounted display, a client apparatus, and the like.

In recent years, a head-mounted display (HMD) has been used as a display device. Since the head-mounted display is mounted on a head, it is not desirable to increase the size of the head-mounted display. Therefore, the operation section (e.g., operation button and the like) used to operate the head-mounted display necessarily has a simple configuration (i.e., it is difficult to perform a complex operation).

A mobile phone or the like has been widely used as a client apparatus used in a mobile environment. A mobile phone or the like can acquire a large amount of contents via a network, but has an insufficient display capability since the size of the display section (display) is limited.

### SUMMARY

According to one aspect of the invention, there is provided a head-mounted display comprising:

a display section that displays a display image;

a communication section that communicates with a client apparatus and an external server system; and

a processing section,

the communication section receiving a Hypertext Transfer Protocol (HTTP) request when the client apparatus has displayed an operation screen used to operate the head-mounted display on a display section of the client apparatus, and transmitted the HTTP request to the head-mounted display based on an operation performed using the operation screen displayed on the display section of the client apparatus,

the processing section executing a command that corresponds to the HTTP request received by the communication section, and

the communication section transmitting an execution result of the command executed by the processing section to the client apparatus as an HTTP response.

According to another aspect of the invention, there is provided a client apparatus comprising:

a display section that displays a display image;

a communication section that communicates with another client apparatus and an external server system; and

a processing section,

the communication section receiving a Hypertext Transfer Protocol (HTTP) request when an operation screen used to operate the client apparatus has been displayed on a display section of the other client apparatus, and the HTTP request has been transmitted to the client apparatus from the other client apparatus based on an operation performed using the operation screen displayed on the display section of the other client apparatus,

the processing section executing a command that corresponds to the HTTP request received by the communication section, and

the communication section transmitting an execution result of the command executed by the processing section to the other client apparatus as an HTTP response.

### BRIEF DESCRIPTION OF THE DRAWINGS

FIG. 1 shows a system configuration example according to a first embodiment.

FIG. 2 is a flowchart illustrating a process according to the first embodiment.

FIG. 3 shows an example of a display image displayed on a display section of a head-mounted display.

FIGS. 4A and 4B show an example in which operation screen information is generated using a template.

FIG. 5 shows an example of an image displayed on a display section of a head-mounted display and an example of an image displayed on a display section of a client apparatus.

FIG. 6 shows a system configuration example according to a second embodiment.

FIG. 7 is a view illustrating an example of a process according to the second embodiment.

FIG. 8 is a flowchart illustrating a process according to the second embodiment.

FIG. 9 shows another example of a display image displayed on a display section of a head-mounted display.

FIGS. 10A and 10B show an example in which application execution information is generated using a template.

FIG. 11 shows an example of data acquired from an external server system.

FIG. 12 shows another example of an image displayed on a display section of a head-mounted display and another example of an image displayed on a display section of a client apparatus.

### DESCRIPTION OF EXEMPLARY EMBODIMENTS

JP-A-10-233772 discloses technology that transmits an HTML document or the like to each terminal connected to a network (e.g., corporate network) via multi-address transmission so that the data can be shared.

JP-A-2000-122957 discloses technology that displays data on a plurality of client terminals in a linked manner.

Several aspects of the invention may provide a head-mounted display that operates in cooperation with a client apparatus by performing a process based on an operation performed using an operation screen displayed on a client apparatus, a client apparatus, and the like.

Several aspects of the invention may provide a head-mounted display and a client apparatus that display screens (images) in a linked manner by displaying related display data on a display section of the head-mounted display and a display section of the client apparatus, and the like.

According to one embodiment of the invention, there is provided a head-mounted display comprising:

a display section that displays a display image;

a communication section that communicates with a client apparatus and an external server system; and

a processing section,

the communication section receiving a Hypertext Transfer Protocol (HTTP) request when the client apparatus has displayed an operation screen used to operate the head-mounted display on a display section of the client apparatus, and transmitted the HTTP request to the head-mounted display based on an operation performed using the operation screen displayed on the display section of the client apparatus,

the processing section executing a command that corresponds to the HTTP request received by the communication section, and

the communication section transmitting an execution result of the command executed by the processing section to the client apparatus as an HTTP response.

The head-mounted display receives the HTTP request from the client apparatus based on an operation performed using the operation screen displayed on the client apparatus, and performs the command process based on the received HTTP request. The head-mounted display transmits the execution result of the command to the client apparatus as the HTTP response. This makes it possible to provide a head-mounted display that operates in cooperation with a client apparatus (particularly a head-mounted display that can be operated using a client apparatus).

In the head-mounted display,

the communication section may receive the HTTP request that includes a parameter for executing an application when the operation screen has been displayed on the display section of the client apparatus, and the parameter has been set using the operation screen, and

the processing section may execute the application in which the parameter has been set based on the parameter.

This makes it possible for the head-mounted display to execute the application based on the parameter set using the client apparatus.

In the head-mounted display,

the processing section may generate display data for the head-mounted display and display data for the client apparatus based on data acquired from the external server system via the communication section by executing the application,

the display section may display the display image based on the display data for the head-mounted display, and

the communication section may transmit the display data for the client apparatus to the client apparatus as the HTTP response.

This makes it possible to generate the display data for the head-mounted display and the display data for the client apparatus, display the display data for the head-mounted display on the display section of the head-mounted display, and transmit the display data for the client apparatus to the client apparatus. Therefore, it is possible to display a plurality of screens in a linked manner using a plurality of display sections.

In the head-mounted display,

the processing section may generate first display data for the head-mounted display to Nth (N is an integer) display data for the head-mounted display and first display data for the client apparatus to Nth display data for the client apparatus based on the data acquired from the external server system,

the display section may sequentially display the first display data for the head-mounted display to the Nth display data for the head-mounted display at given display intervals when ith (i is an integer that satisfies a relationship “1≦i≦N”) display data for the head-mounted display among the first display data for the head-mounted display to the Nth display data for the head-mounted display and ith display data for the client apparatus among the first display data for the client apparatus to the Nth display data for the client apparatus are related data, and

the communication section may transmit the ith display data for the client apparatus to the client apparatus when the ith display data for the head-mounted display is displayed on the display section.

This makes it possible to ensure that related data is displayed on the head-mounted display and the client apparatus when a plurality of pieces of display data for head-mounted display and a plurality of pieces of display data for client apparatus are provided.

In the head-mounted display,

the communication section may transmit the display data for the client apparatus to the client apparatus as the HTTP response that corresponds to the HTTP request when the client apparatus has transmitted the parameter for executing the application as the HTTP request.

This makes it possible to reliably link the HTTP request and the HTTP response.

In the head-mounted display,

the communication section may access contents that correspond to a given uniform resource locator (URL), and may receive the contents when the HTTP request from the client apparatus is an instruction to display the contents that correspond to the given URL, and

the display section may display the contents received by the communication section.

This makes it possible to display the contents that correspond to a given URL when an instruction to display the contents that correspond to the given URL has been received from the client apparatus 100 as the HTTP request.

In the head-mounted display,

the processing section may execute the command based on the HTTP request from the client apparatus when the HTTP request is at least one command among a command to move a cursor within the display image, a command to select contents designated by the cursor, and a command to return to a previous screen, and

the display section may update the display image corresponding to the execution result of the command, and may display the updated display image.

This makes it possible to execute at least one command among the command to move the cursor, the command to select the contents designated by the cursor, and the command to return to the previous screen that has been received from the client apparatus as the HTTP request.

The head-mounted display may further comprise:

a template storage section that stores a template of operation screen information, the operation screen information being information for displaying the operation screen on the display section of the client apparatus,

the processing section may generate the operation screen information by embedding address information about the head-mounted display in the template of the operation screen information that is stored in the template storage section.

The operation screen information generation process can be simplified by utilizing the template.

In the head-mounted display,

the template storage section may store a template of an application executed by the head-mounted display,

the communication section may receive a parameter for executing the application that has been set using the operation screen displayed on the display section of the client apparatus, and

the processing section may generate the application executed by the head-mounted display by embedding the parameter received by the communication section in the template of the application that is stored in the template storage section.

The application generation process can be simplified by utilizing the template.

In the head-mounted display,

the processing section may generate operation screen information when the communication section has received an initial connection request as the HTTP request from the client apparatus, the operation screen information being information for displaying the operation screen on the display section of the client apparatus, and

the communication section may transmit the operation screen information that has been generated by the processing section to the client apparatus as the HTTP response.

According to this configuration, the head-mounted display can be operated using the client apparatus by transmitting the operation screen information as the HTTP response when the initial connection request has been transmitted from the client apparatus.

In the head-mounted display,

the display section may display address information about the head-mounted display as the display image,

the communication section may receive a request from the client apparatus that has been issued using a web browser based on the address information displayed on the display section as the initial connection request,

the processing section may generate the operation screen information, and

the communication section may transmit the operation screen information that has been generated by the processing section to the client apparatus as the HTTP response.

This makes it possible to issue the initial connection request even when the client apparatus utilizes a web browser.

In the head-mounted display,

the communication section may receive screen information written in Hypertext Markup Language (HTML) from the client apparatus as the HTTP request, and

the display section may display the display image that has been generated based on the screen information written in HTML that has been received by the communication section.

This makes it possible to use the head-mounted display as a second display of the client apparatus.

According to another embodiment of the invention, there is provided a client apparatus comprising:

a display section that displays a display image;

a communication section that communicates with another client apparatus and an external server system; and

a processing section,

the communication section receiving a Hypertext Transfer Protocol (HTTP) request when an operation screen used to operate the client apparatus has been displayed on a display section of the other client apparatus, and the HTTP request has been transmitted to the client apparatus from the other client apparatus based on an operation performed using the operation screen displayed on the display section of the other client apparatus,

the processing section executing a command that corresponds to the HTTP request received by the communication section, and

the communication section transmitting an execution result of the command executed by the processing section to the other client apparatus as an HTTP response.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

### 1. Method

A method according to several embodiments of the invention is described below. A head-mounted display (HMD) that has been used as a display device in recent years has a limited size and the like since the head-mounted display is mounted on a head. Therefore, the head-mounted display is generally provided with an operation section having a simple configuration. It is difficult to implement a complex operation using the head-mounted display since the operation interface is poor as compared with a mobile device such as a mobile phone.

A mobile device (e.g., mobile phone) normally has a small display section, and has an insufficient display capability.

The above problem may be solved by causing a head-mounted display and a client apparatus (e.g., mobile phone) within the same LAN environment to operate in cooperation (in a linked manner). Specifically, the head-mounted display receives an HTTP request from the client apparatus, executes a command that corresponds to the received HTTP request, and transmits the execution result of the command to the client apparatus as an HTTP response. The head-mounted display can be operated using the client apparatus by utilizing an operation instruction command as the HTTP request. This makes it possible to deal with the problem associated with the operation section of the head-mounted display. It is possible to deal with the problem associated with the display section of the client apparatus (e.g., mobile device or mobile phone) by displaying a plurality of screens that display related data on the display sections of the devices.

A first embodiment and a second embodiment of the invention are described below. The first embodiment illustrates a method that utilizes a client apparatus as an operation section (remote controller) of a head-mounted display. The second embodiment illustrates a method that displays a plurality of linked (related) screens using the display section of a head-mounted display and the display section of a client apparatus based on data acquired from an external server system taking a gourmet application (restaurant search application) as an example.

### 2. First Embodiment

A method that utilizes a client apparatus as an operation section (remote controller) of a head-mounted display is described below. A system configuration example will be described first, and the details of a process will then be described using a flowchart.

### 2.1 System Configuration Example

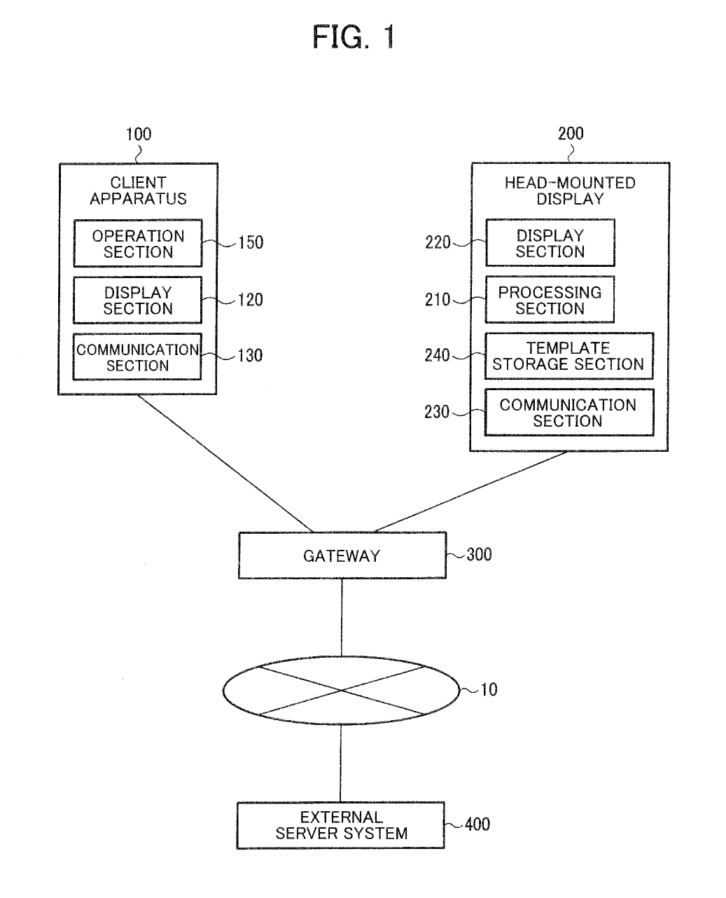

FIG. 1 shows a configuration example of a system that includes a head-mounted display according to the first embodiment. The system includes a client apparatus 100, a head-mounted display 200, a gateway 300, and an external server system 400. Note that the system is not limited to the configuration shown in FIG. 1. Various modifications may be made, such as omitting some of the elements shown in FIG. 1 or adding other elements. The client apparatus 100 and the head-mounted display 200 are owned (carried or possessed) by the user. The gateway 300 may or may not be owned by the user. The client apparatus 100 or the head-mounted display 200 may include the gateway 300.

The client apparatus 100 includes an operation section 150, a display section 120, and a communication section 130. The operation section 150 allows the user to perform various operations. The operation section 150 includes a touch panel, an operation key, and the like. The display section 120 displays a display image. The communication section 130 communicates with the head-mounted display 200 via the gateway 300. The communication section 130 may communicate with the external server system via the gateway 300 and a network 10.

The head-mounted display 200 includes a processing section 210, a display section 220, a communication section 230, and a template storage section 240. The processing section 210 performs various processes. For example, the processing section 210 executes a command that corresponds to an HTTP request from the client apparatus. The display section 220 displays a display image. The communication section 230 communicates with the client apparatus 100 via the gateway 300. The communication section 230 may communicate with the server system 400 via the gateway 300 and the network 10. The template storage section 240 stores a template of contents displayed on the display section 120 of the client apparatus 100. For example, the template storage section 240 stores a template of an operation screen that is used to operate the head-mounted display 200.

The gateway 300 allows a plurality of terminals to be connected to the network 10 using Network Address Port Translation (NAPT) or the like. The gateway 300 may have a Dynamic Host Configuration Protocol (DHCP) server function, and may dynamically assign a private IP address to an instrument (e.g., client apparatus 100 and head-mounted display 200) connected to the network 10.

### 2.2 Details of Process

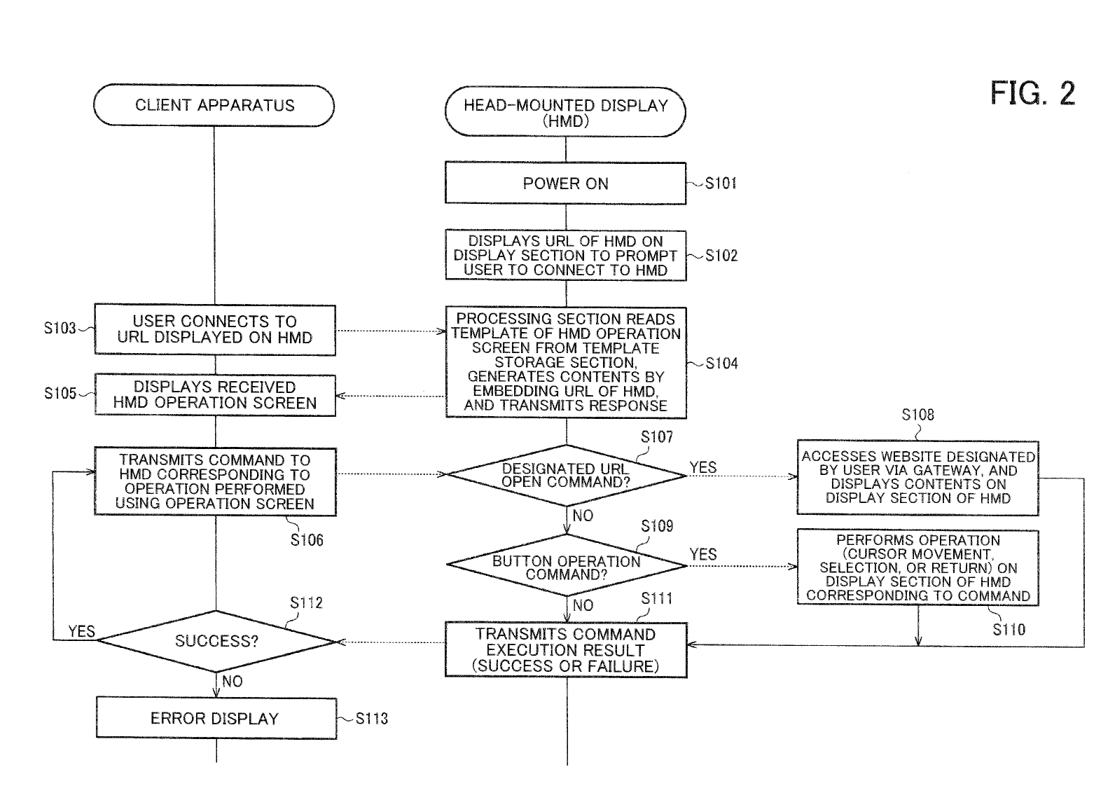

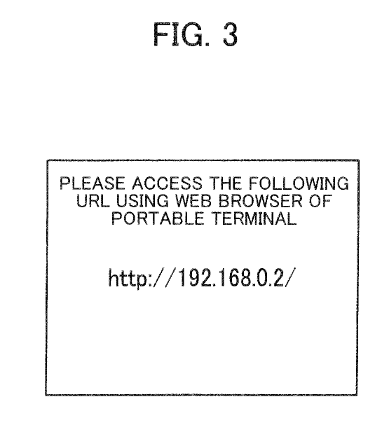

The details of a process are described below using a flowchart shown in FIG. 2. In a step S101, the head-mounted display 200 is turned ON. The URL of the head-mounted display 200 is displayed on the display section 220 of the head-mounted display 200 (see FIG. 3) (S102). The client apparatus 100 connects to the head-mounted display 200 based on the URL displayed on the display section 220 (S103).

When the client apparatus 100 has connected to the head-mounted display 200, the processing section 210 of the head-mounted display 200 reads a template of operation screen information from the template storage section 240, and embeds the URL of the head-mounted display 200 in the template to generate operation screen information.

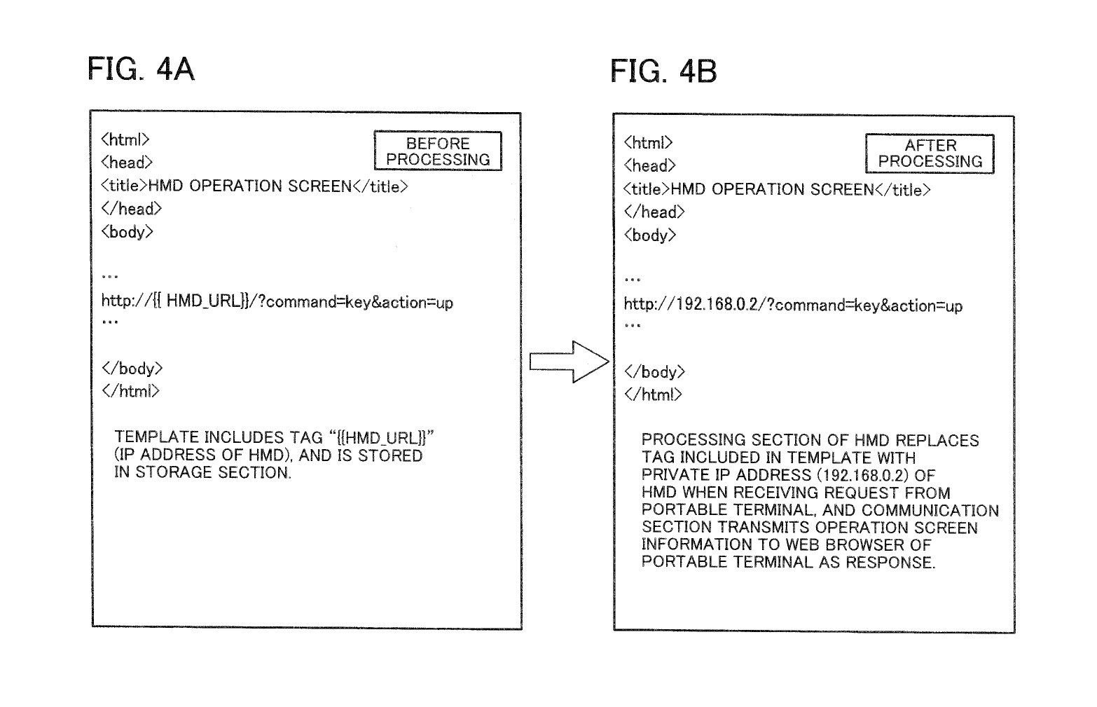

FIGS. 4A and 4B show a specific example of the template and the embedding process. In FIGS. 4A and 4B, a command is provided in an HTML document (FIG. 4A) used as the template, and includes a tag “{{HMD_URL}}”. The operation screen information (FIG. 4B) generated based on the template is an HTML document generated by replacing the tag with the URL (IP address) of the head-mounted display.

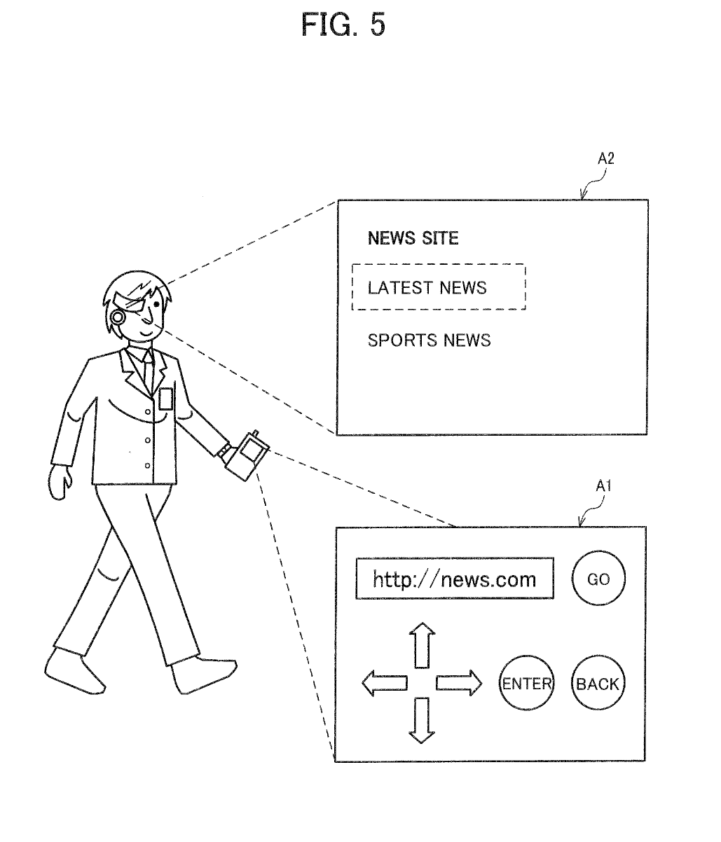

The communication section 230 transmits the generated operation screen information to the client apparatus 100 (S104), and the client apparatus 100 displays an operation screen on the display section 120 based on the received operation screen information (S105). FIG. 5 shows a specific example of the operation screen and a specific example of a screen displayed on the head-mounted display 200 that is operated using the operation screen.

For example, a text input area, a GO button, an arrow key, an ENTER button, a BACK button, and the like are displayed on the display section 120 of the client apparatus 100 (see A1 in FIG. 5). When the user has input the URL of the desired site in the text input area, and pressed the GO button, the corresponding contents are displayed on the display section 220 of the head-mounted display 200 (see A2 in FIG. 5). The user can go to another page or select a link in the contents by pressing the arrow key in a state in which the contents are displayed on the display section 220. The broken line (see A2) shown in FIG. 5 indicates an example in which a link in the contents is selected. When the user has pressed the ENTER button in a state in which the link is selected, the link destination page is displayed. When the user has pressed the BACK button, the previous page (display screen) is displayed.

Note that the steps S101 to S105 are provided on the assumption that the client apparatus 100 connects to the head-mounted display 200 utilizing a web browser. Specifically, the steps S101 to S105 are provided on the assumption that the client apparatus 100 cannot acquire the IP address of another terminal within the same LAN environment. The process can be simplified when using a dedicated application other than a web browser.

For example, the client apparatus 100 may connect to the head-mounted display 200 utilizing a dedicated application (that can determine the IP address of another terminal within the same LAN environment) instead of prompting the user to input the displayed URL (S102 and S103). Alternatively, the client apparatus 100 may generate the operation screen information (i.e., the steps S101 to S105 may be omitted). Specifically, the client apparatus 100 may generate the operation screen information when the client apparatus 100 has determined the IP address of the head-mounted display 200, and may display the operation screen on the display section 120 based on the operation screen information. In this case, the information used as the template must be stored in the client apparatus 100 instead of the template storage section 240 of the head-mounted display 200.

When the client apparatus 100 has displayed the operation screen on the display section 120, the client apparatus 100 transmits a command to the head-mounted display 200 based on an operation performed using the operation screen (S106). Specific examples of the command transmitted to the head-mounted display 200 are shown below.
(1) http://192.168.0.2/?command=open&url=http://news.com
(2) http://192.168.0.2/?command=key&action=up

These commands are written in the form of a URL, and are transmitted as an HTTP request. The URL (192.168.0.2 (IP address)) of the head-mounted display 200 follows a character string “http://”, and the name and the value of each parameter (connected by “=”) follow a character string “/?”. A character “&” is written between a plurality of parameters.

In the command (1), the value of the parameter “command” is set to “open”, and the value of the parameter “url” is set to “http://news.com”. The information (command (1)) is transmitted to the terminal corresponding to the IP address “192.168.0.2”. For example, the command (1) is transmitted to the head-mounted display 200 when the user has input “http://news.com” in the text input area, and pressed the GO button.

In the command (2), the value of the parameter “command” is set to “key”, and the value of the parameter “action” is set to “up”. For example, the command (2) is transmitted to the head-mounted display 200 when the user has pressed the UP button (arrow key). When the value of the parameter “command” is set to “key” (i.e., key operation command), a command that corresponds to another key operation can be transmitted by changing the value of the parameter “action”. For example, when the value of the parameter “action” is set to “down”, “left”, or “right”, the command is transmitted when the user has pressed the DOWN, LEFT, or RIGHT button (arrow key). When the value of the parameter “action” is set to “enter” or “back”, the command is transmitted when the user has pressed the ENTER button or the BACK button.

When the head-mounted display 200 has received the command, the head-mounted display 200 determines whether or not the received command is a command that opens the designated URL (S107). Specifically, the head-mounted display 200 checks the value of the parameter “command” of the command (HTTP request). The head-mounted display 200 determines that the received command is a command that opens the designated URL when the value of the parameter “command” is set to “open”, and determines that the received command is not a command that opens the designated URL when the value of the parameter “command” is not set to “open”. When the head-mounted display 200 has determined that the received command is a command that opens the designated URL, the head-mounted display 200 accesses the site corresponding to the designated URL (i.e., the URL set as the value of the parameter “url” via the gateway 300, and displays the contents on the display section 220 (S108).

When the head-mounted display 200 has determined that the received command is not a command that opens the designated URL, the head-mounted display 200 determines whether or not the received command is a key operation command (S109). Specifically, the head-mounted display 200 checks the value of the parameter “command” of the command (HTTP request). The head-mounted display 200 determines that the received command is a key operation command when the value of the parameter “command” is set to “key”, and determines that the received command is not is a key operation command when the value of the parameter “command” is not set to “key”. When the head-mounted display 200 has determined that the received command is a key operation command, the head-mounted display 200 performs a page change process, a link selection process, a link destination page display process, or a previous page display process corresponding to the command (i.e., the value of the parameter “action”) (S110). When the head-mounted display 200 has determined that the received command is not a key operation command in the step S109, or has completed the steps S108 and S110, the head-mounted display 200 transmits the command execution result (success or failure) to the client apparatus 100 as an HTTP response (S111).

The client apparatus 100 determines (checks) the received command execution result (S112). The client apparatus 100 performs the step S106 when the received command execution result is “success”, and displays an error message on the display section 120 when the received command execution result is “failure” (S113).

According to the first embodiment, the head-mounted display 200 includes the display section 220 that displays a display image, the communication section 230, and the processing section 210 (see FIG. 1). The communication section 230 communicates with the client apparatus 100 and the external server system 400. When the client apparatus 100 has displayed the operation screen used to operate the head-mounted display 200 on the display section 120, and transmitted an HTTP request to the head-mounted display 200 based on an operation performed using the operation screen, the communication section 230 of the head-mounted display 200 receives the HTTP request, and the processing section 210 executes the command that corresponds to the received HTTP request. The communication section 230 transmits the execution result of the command executed by the processing section 210 to the client apparatus 100 as an HTTP response.

Note that the term “HTTP (Hypertext Transfer Protocol) request” used herein refers to a request that is transmitted from a web browser to a web server when a character string that starts from “http” (refer to the commands (1) and (2)) has been input to the web browser, and executed, for example. More specifically, the HTTP request includes a request line that includes a method name, the URL (e.g., a character string that starts from “http”) of the target contents, and the version of HTTP, such as GET http://192.168.0.2/?command=key&action=up HTTP/1.1.

Note that HTTP specifies a POST method, a HEAD method, and the like in addition to the GET method. A header that specifies a language and a data format may be provided in addition to the request line. A body that specifies data transmitted to a server may be provided when using the POST method or the like. Note that the HTTP request need not necessarily be transmitted by the web browser. The HTTP request may be transmitted by a dedicated application that is compliant with HTTP.

This makes it possible for the head-mounted display 200 and the client apparatus 100 to operate in cooperation. More specifically, the head-mounted display 200 performs a process in response to a request (HTTP request) from the client apparatus, and transmits the result (HTTP response) to the client apparatus. For example, when the HTTP request is an operation request (operation command) to the head-mounted display 200 that has been transmitted based on an operation performed using the operation screen displayed on the display section 120 of the client apparatus 100, the head-mounted display 200 can be operated using the client apparatus 100. Since the head-mounted display 200 is mounted on a head, it is difficult to provide the head-mounted display 200 with an operation section that allows the user to perform a complex operation. Therefore, it is very useful if the head-mounted display 200 can be operated using another instrument (client apparatus 100 (e.g., mobile phone)). In the first embodiment, the HTTP request is an operation request issued to the head-mounted display 200, and the command process performed by the head-mounted display 200 is a web access process or the like. The HTTP response is the result (success or failure) of the command process. In the second embodiment, the HTTP request is an operation request (particularly an application parameter setting request) to the head-mounted display 200, and the command process is execution of an application (web application). The HTTP response is display data that is generated when the application has been executed, for example.

In the first embodiment, HTTP is used as the communication protocol. A web browser is widely known as an application that allows a client to utilize HTTP. Specifically, a web browser can be used by utilizing HTTP. At present, a web browser is normally provided in (can be easily introduced into) a terminal having a communication function (e.g., mobile phone). Therefore, a general-purpose terminal can be used as the client apparatus 100 (i.e., a dedicated terminal need not be provided).

Note that the term “HTTP” used herein includes a standard (e.g., Hypertext Transfer Protocol over Secure Socket Layer (HTTPS)) developed from HTTP and a standard based on an idea (concept) similar to that of HTTP in addition to HTTP in a narrow sense. For example, HTTPS may be used when a security function is regarded as important. A message is sent using plain text when employing HTTP in a narrow sense, while an authentication process and a message encoding process are performed when employing HTTPS. Therefore, interception of communication between the client and the server can be prevented by utilizing HTTPS. For example, when an authentication process using the user name and the password is performed when acquiring data from the external server system 400, it is desirable to use HTTPS so that the user name and the password are not misused by a third party. HTTPS may also be used when the client apparatus 100 and the head-mounted display 200 are connected via the gateway 300 in a state in which an unspecified number of people can use the connection service (e.g., hot spot). Since a web browser is compliant with HTTPS in addition to HTTP, the advantages achieved by utilizing HTTP are also achieved when utilizing HTTPS.

The communication section 230 accesses contents that correspond to a given URL, and receives the contents when the HTTP request from the client apparatus 100 is an instruction to display the contents that correspond to the given URL. The display section 220 displays the contents received by the communication section 230.

This makes it possible to access the contents that correspond to the given URL by operating the head-mounted display 200 using the client apparatus 100. More specifically, when the user has input the URL of the access target contents in the text input area of the operation screen (see A1 in FIG. 5), and pressed the GO button, the contents that correspond to the input URL can be displayed on the display section 220 of the head-mounted display 200, for example.

When the HTTP request from the client apparatus is at least one command among a command to move a cursor within the display image (i.e., an image displayed on the display section 220 of the head-mounted display 200), a command to select contents designated by the cursor, and a command to return to the previous screen, the processing section 210 executes the command based on the HTTP request, and the display section 220 updates the display image corresponding to the execution result of the command.

This makes it possible to execute at least one command among the command to move the cursor, the command to select the contents designated by the cursor, and the command to return to the previous screen by operating the head-mounted display 200 using the client apparatus 100. More specifically, the cursor (see A2 in FIG. 5) that is indicated by the broken line that encloses the link can be moved within the display image by operating the arrow key displayed within the operation screen (see A1 of FIG. 5). Alternatively, the contents (e.g., the contents of the link destination page) designated by the cursor can be selected by pressing the ENTER button, or the previous display image (screen) can be displayed by pressing the BACK button. Note that the operation that can be performed is not limited thereto. A screen scroll process, a display tab selection process (e.g., when the display screen can be displayed as a tab), and the like can also be performed. Specifically, an arbitrary operation can be performed by changing the format of the operation screen, or changing the function assigned to each button.

As shown in FIG. 1, the head-mounted display 200 includes the template storage section 240 that stores a template. The term “template” used herein refers to a template of the operation screen information that is information for displaying the operation screen on the display section 120 of the client apparatus 100. The processing section 210 may generate the operation screen information by embedding address information about the head-mounted display 200 in the template of the operation screen information.

This makes it possible to simplify the operation screen information generation process by utilizing the template. In the first embodiment, the head-mounted display 200 and the client apparatus 100 connected via the network (e.g., provided in the same LAN environment) operate in cooperation. The head-mounted display 200 performs a process using the HTTP request from the client apparatus 100. Since the HTTP request transmitted from the client apparatus 100 must be transmitted to the head-mounted display 200, the address information (e.g., IP address) about the head-mounted display 200 is embedded in the template. When the system according to the first embodiment utilizes Dynamic Host Configuration Protocol (DHCP), the IP address of the head-mounted display 200 may change dynamically. The process that embeds the address information in the template is particularly effective when using DHCP. Specifically, the operation screen information can be dynamically generated corresponding to a change in the IP address of the head-mounted display 200 by embedding the IP address of the head-mounted display 200 in the template.

The processing section 210 may generate the operation screen information when the communication section 230 has received an initial connection request as the HTTP request from the client apparatus 100, and the communication section 230 may transmit the operation screen information generated by the processing section 210 to the client apparatus as the HTTP response.

Specifically, the head-mounted display 200 can generate the operation screen information in response to the initial connection request (e.g., the HTTP request when the head-mounted display 200 is connected to the client apparatus 100 for the first time) from the client apparatus 100, and transmit the operation screen information to the client apparatus 100. Since the head-mounted display 200 can transmit the operation screen information to the client apparatus 100 when the head-mounted display 200 and the client apparatus 100 start to operate in cooperation, the head-mounted display 200 can be operated using the client apparatus 100.

The display section 220 may display the address information about the head-mounted display 200 as the display image (see FIG. 3), and the communication section 230 may receive a request from the client apparatus that has been issued using a web browser based on the address information displayed on the display section 220 as the initial connection request.

This makes it possible for the head-mounted display 200 and the client apparatus 100 to operate in cooperation even when the client apparatus 100 utilizes a web browser. A web browser cannot acquire the address information (IP address) about another terminal within the same LAN environment. Therefore, the client apparatus 100 cannot initially access the head-mounted display 200 in a simple way. This makes it necessary to prompt the user who operates the client apparatus 100 to access the head-mounted display 200 by displaying the address information (IP address) about the head-mounted display 200 on the display section 220 of the head-mounted display 200, for example. The address information may be displayed by displaying a character string that indicates the address information, or may be displayed by displaying a QR code or the like that corresponds to the character string.

The communication section 230 may receive screen information written in HTML from the client apparatus as the HTTP request. The display section 220 may display the display image that has been generated based on the screen information written in HTML.

Examples of the HTTP request include http://192.168.0.2/?command=display&content=<html><head><title>title<title></hea d><body><img src=“http://www.a.com/1.jpg”></body></html>.

“192.168.0.2” is the IP address of the head-mounted display 200. The value of the parameter “command” is set to “display”, and the value of the parameter “content” is set to the contents written in HTML. Specifically, the client apparatus 100 transmits the screen information in which one of the parameters is written in HTML, and the head-mounted display 200 interprets and displays the value of the parameter “content” when the value of the parameter “command” is set to “display”.

This makes it possible to use the head-mounted display 200 as a second display of the client apparatus 100. For example, when the client apparatus 100 is a mobile phone (smartphone), the mobile phone may receive an HTML file by executing an application provided in the mobile phone. If the contents of the received HTML file are directly transmitted to the head-mounted display 200 as the HTTP request, the screen information acquired by the application can be displayed on the head-mounted display 200. Since a mobile device such as a mobile phone is provided with a small display section from the viewpoint of portability, it is very useful to increase the display area by utilizing the display section of the head-mounted display 200 in addition to the display section of the mobile phone. In this case, the HTTP response is the result (success or failure) of the display process, for example.

The first embodiment also relates to a client apparatus that includes a display section, a communication section, and a processing section. When implementing a system in which a plurality of client apparatuses operate in cooperation, the communication section communicates with another client apparatus and the external server system. The operation screen used to operate the client apparatus is displayed on the display section of another client apparatus, and an HTTP request is transmitted to the client apparatus from the other client apparatus based on an operation performed using the displayed operation screen. In this case, the communication section of the client apparatus receives the HTTP request, and the processing section executes a command that corresponds to the received HTTP request. The communication section transmits the execution result of the command executed by the processing section to the other client apparatus as the HTTP response.

This makes it possible to apply the method according to the first embodiment to a device other than the head-mounted display 200. For example, the method according to the first embodiment may be applied to an arbitrary client apparatus (e.g., mobile phone, PHS, or tablet terminal) that has a network function and includes a display section.

### 3. Second Embodiment

A method that displays a plurality of screens using the display section of a head-mounted display and the display section of a client apparatus based on data acquired from an external server system is described below taking a gourmet application (restaurant search application) as an example. A system configuration example will be described first, and the details of a process will then be described using a flowchart.

### 3.1 System Configuration Example

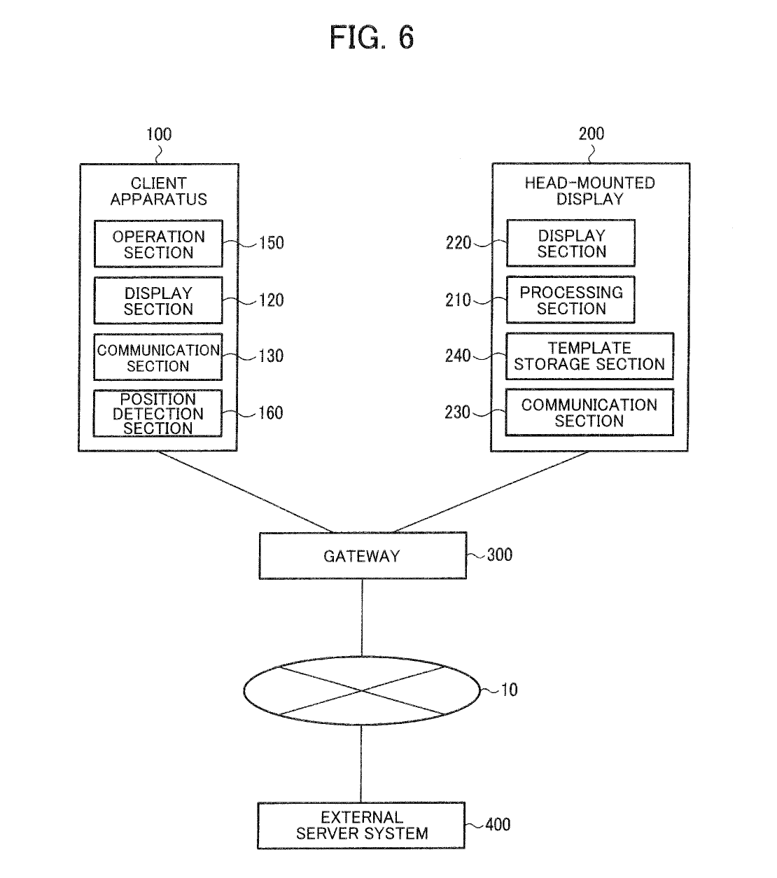

FIG. 6 shows a configuration example of a system that includes a head-mounted display according to the second embodiment. The system includes a client apparatus 100, a head-mounted display 200, a gateway 300, and an external server system 400. Note that the system is not limited to the configuration shown in FIG. 6. Various modifications may be made, such as omitting some of the elements shown in FIG. 6 or adding other elements.

The second embodiment differs from the first embodiment in that the client apparatus 100 further includes a position detection section 160 (see FIG. 6). The position detection section 160 acquires the latitude and the longitude of the current position of the client apparatus 100 using the GPS, WiFi, or the like. Note that the position detection section 160 is used for the gourmet application (i.e., application), and need not necessarily be provided.

The second embodiment also differs from the first embodiment in that a template of the operation screen information transmitted to the client apparatus 100 and an application execution template for an application executed by the head-mounted display 200 are stored in the template storage section 240 of the head-mounted display 200. The template of the operation screen information is the same as that described in connection with the first embodiment, and is used in a step S204 that corresponds to the step S104. The application execution template is used in a step S207. The details of the application execution template are described later.

A mashup server or the like is used as the external server system 400 instead of a web server or the like.

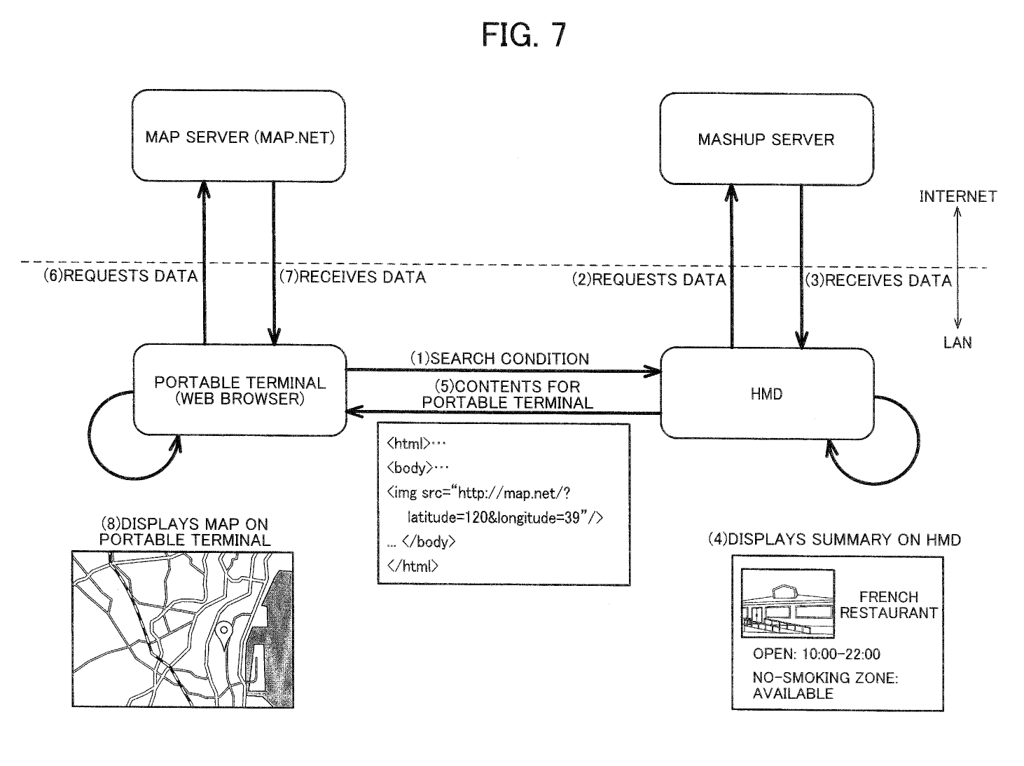

A configuration example according to the second embodiment is described below with reference to FIG. 7. When a portable terminal (client apparatus 100 in a broad sense) has transmitted a search condition to an HMD (head-mounted display 200), the HMD transmits a data request to a mashup server (external server system 400 in a broad sense), and acquires data ((1) to (3)). The HMD displays a summary on the display section, generate contents for the portable terminal, and transmits the generated contents to the portable terminal ((4) and (5)). The portable terminal displays the received contents (map information in this example) ((8)). When the contents include a reference to another server (see FIG. 7), the portable terminal accesses the other server ((6) and (7)).

In FIG. 7, the HMD communicates directly with the mashup server, and the portable terminal communicates directly with the map server for convenience of illustration. Note that the client apparatus 100 and the head-mounted display 200 are terminals within the same LAN environment, and connected to the network 10 via the gateway 300 (see FIG. 1). Therefore, access via the LAN and the Internet ((2) and (3) or (6) and (7)) occurs via the gateway 300 (e.g., occurs after converting (translating) the address and the port number by utilizing NAPT or the like).

### 3.2 Details of Process

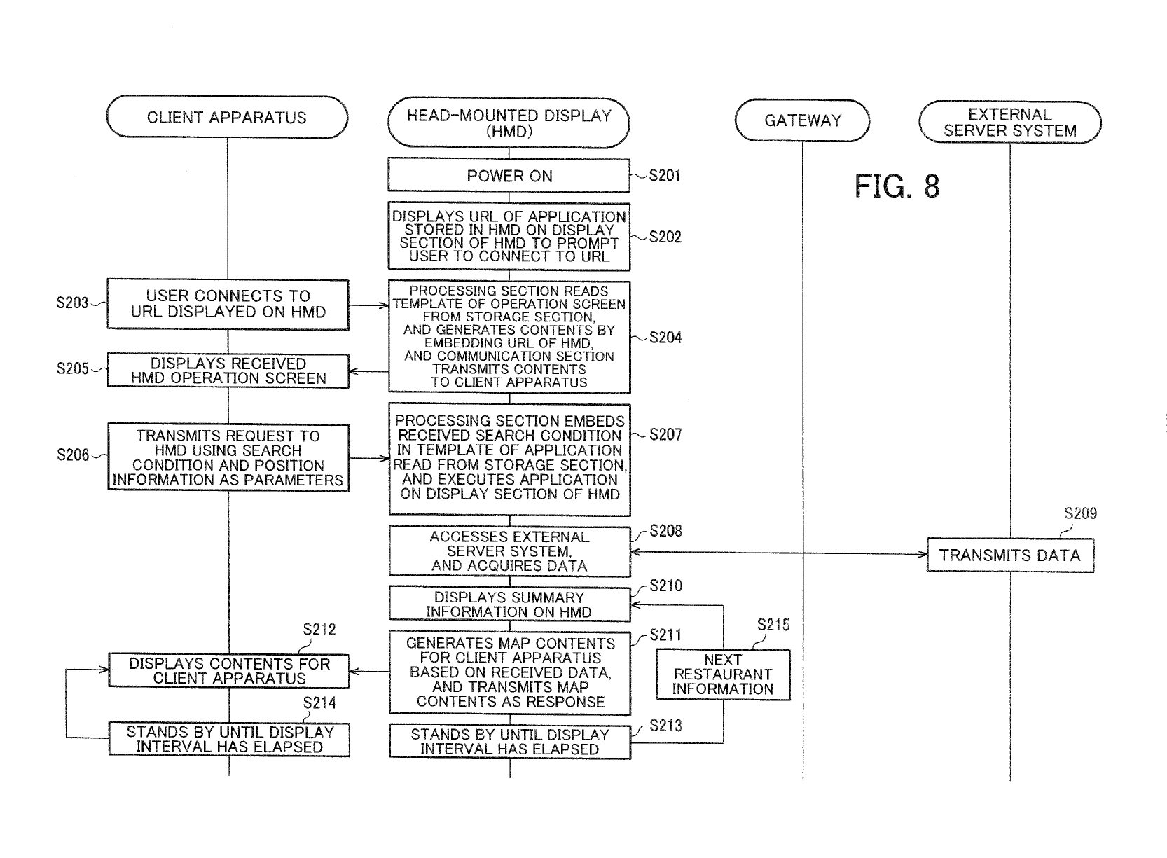

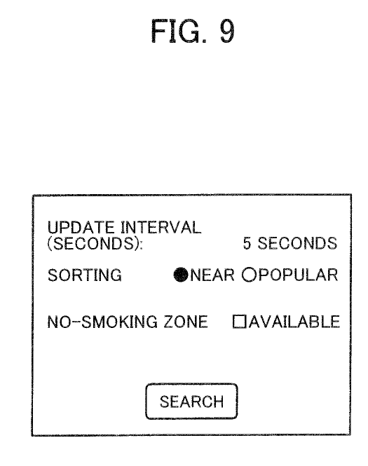

The details of a process are described below using a flowchart shown in FIG. 8. The process includes steps S201 to S205. The steps S201 to S205 are respectively the same as the steps S101 to S105 described in connection with the first embodiment. Therefore, detailed description thereof is omitted. Note that the operation screen that is transmitted in the step S104 and displayed in the step S105 is used to operate the head-mounted display 200 (see A1 in FIG. 5, for example). In the second embodiment, the operation screen that is transmitted in the step S204 and displayed in the step S205 is used to set the application executed by the head-mounted display 200 (see FIG. 9, for example). The steps S201 to S205 are provided on the assumption that a web browser is used, and can be simplified in the same manner as the steps S101 to S105 when using a dedicated application.

When the client apparatus 100 has displayed the operation screen on the display section 120, the client apparatus 100 transmits an HTTP request to the head-mounted display 200 (S206). A specific example of the HTTP request transmitted to the head-mounted display 200 is shown below. http://192.168.0.2/? app=gourmet&interval=5000&nosmoking=yes&sort=near&latitude=35&longitude=120

The URL (192.168.0.2 (IP address)) of the head-mounted display 200 follows a character string “http://”, and the name and the value of each parameter (connected by “=”) follow a character string “/?”. A character “&” is written between a plurality of parameters. The URL of the head-mounted display 200 is embedded by the template process in the 5204 in the same manner as in the first embodiment.

“app”, “interval”, “nosmoking”, “sort”, “latitude”, and “longitude” are set as parameters. The parameter “app” indicates the type of the execution target application. Since the value of the parameter “app” is “gourmet”, a gourmet application is executed. Another application can be executed by changing the value of the parameter “app”. The parameter “interval” indicates the update time of the information displayed on the display section 220 of the head-mounted display 200 (5000 ms in this example), and the parameter “nosmoking” indicates filtering the restaurant information based on the presence or absence of a no-smoking zone (seat). The parameter “sort” indicates the sorting order of the restaurants. Since the value of the parameter “sort” is set to “near”, the restaurants are displayed in order from the nearest restaurant. The values of the parameters “latitude” and “longitude” are set to the latitude information and the longitude information acquired by the position detection section 160. Note that a parameter other than the above parameters may also be used.

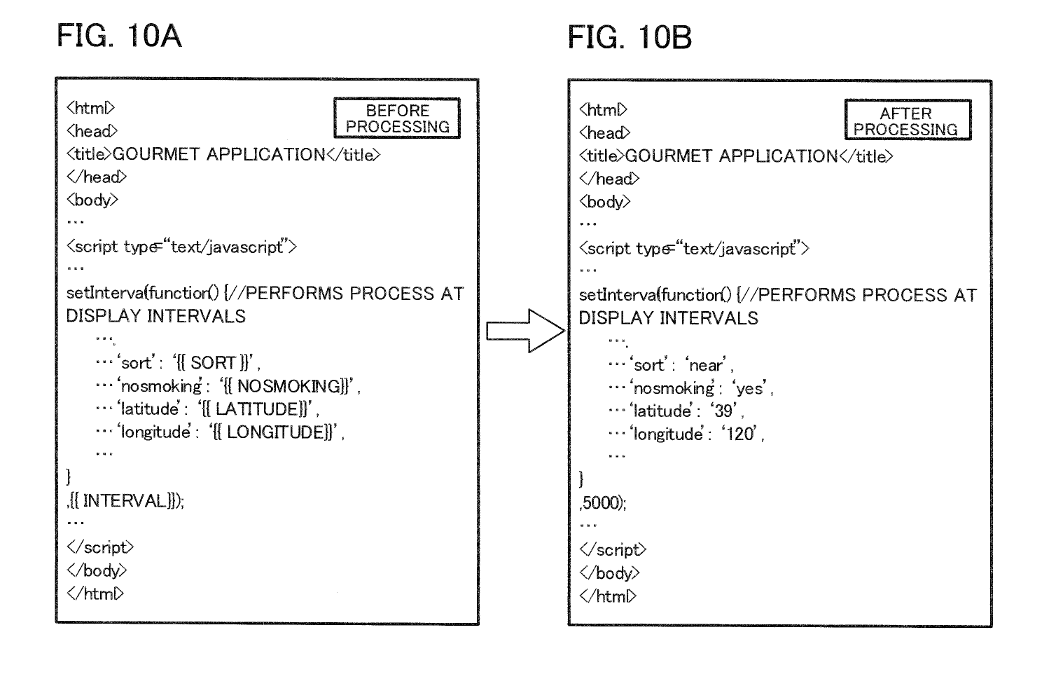

When the head-mounted display 200 has received the HTTP request, the processing section 210 reads the application execution template from the template storage section 240, embeds the received parameters in the application execution template, and executes the application (S207). FIGS. 10A and 10B show a specific example of the above process. FIG. 10A shows an example of the application execution template in which the values of the parameters are set to {{SORT}} and the like. FIG. 10B shows an application that is generated by embedding the received parameters in the template. The application shown in FIG. 10B is executed in the step S207.

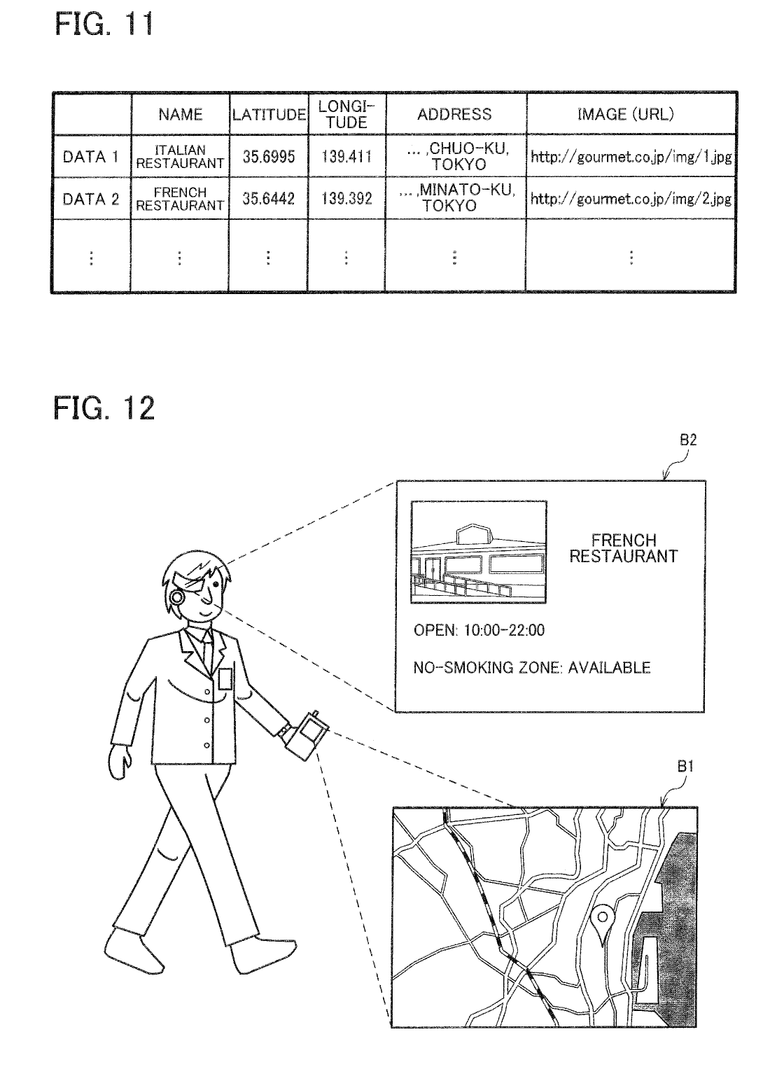

When the application has been executed, the head-mounted display 200 transmits a data request to the external server system 400 (S208). The external server system 400 transmits data in response to the request (S209). FIG. 11 shows an example of the format of the data transmitted from the external server system 400. For example, data corresponding to one restaurant includes the name, the latitude, the longitude, and the address of the restaurant, and the URL of an image of the restaurant. The external server system 400 transmits data corresponding to a plurality of restaurants at one time. The data format may be a JSONP format or an XML format. The elements of the data are not limited to the name, latitude, longitude, and the like shown in FIG. 11.

When the head-mounted display 200 has acquired the data from the external server system 400, the head-mounted display 200 generates display data for the head-mounted display based on the acquired data, and displays the display data on the display section 220 (S210). The head-mounted display 200 also generates display data for the client apparatus based on the acquired data, and transmits the generated display data to the client apparatus 100 as the HTTP response. The HTTP response makes a pair with the HTTP request transmitted in the step S206.

The client apparatus 100 displays contents for the client apparatus on the display section 120 based on the received display data. FIG. 12 shows an example of the screen displayed on the display section 120 of the client apparatus 100 and an example of the screen displayed on the display section 220 of the head-mounted display 200. For example, summary information about the restaurant is displayed on the head-mounted display 200 (see B2 in FIG. 12), and map information about the restaurant is displayed on the client apparatus 100 (see B1 in FIG. 12).

The display process on the first restaurant ends when a given time has elapsed, and the second restaurant is displayed. The display change timing is set using the parameter “interval”, for example. In this example, the head-mounted display 200 and the client apparatus 100 stand by for 5000 ms (S213, S214). When a given time has elapsed, the head-mounted display 200 generates display data for the head-mounted display based on the data about the second restaurant, and displays a summary of the second restaurant on the display section 220 (S210). The head-mounted display 200 then generates display data for the client apparatus, and transmits the generated display data to the client apparatus 100. The above process is similarly performed on the third and subsequent restaurants.

According to the second embodiment, the operation screen is displayed on the display section 120 of the client apparatus 100. When a parameter for executing an application has been set using the operation screen, the communication section 230 of the head-mounted display 200 receives an HTTP request that includes the parameter, and the processing section 210 executes the application in which the parameter has been set based on the parameter.

Examples of the parameter include the parameters “app”, “interval”, “nosmoking”, “sort”, “latitude”, “longitude”, and the like. The parameter indicates the type of application and the application execution condition. Note that a parameter other than the above parameters may also be used.

This makes it possible to set the parameter for executing an application using the operation screen displayed on the display section 120 of the client apparatus 100. Specifically, the user can perform an operation for executing an application using the client apparatus 100. The operation section of the head-mounted display 200 that is likely to have a simple configuration can thus be compensated by utilizing the client apparatus 100 in the same manner as in the first embodiment.

The processing section 210 generates display data for the head-mounted display and display data for the client apparatus based on data acquired from the external server system 400 via the communication section 230 by executing the application. The display section 220 displays the display image based on the display data for the head-mounted display, and the communication section 230 transmits the display data for the client apparatus to the client apparatus 100 as the HTTP response.

This makes it possible to generate the display data for the head-mounted display and the display data for the client apparatus, display the display data for the head-mounted display on the display section 220, and transmit the display data for the client apparatus to the client apparatus 100. Specifically, it is possible to display a plurality of screens using the display section of the head-mounted display 200 and the display section of the client apparatus 100. More specifically, when the data shown in FIG. 11 has been acquired, data that corresponds to the display example indicated by B2 in FIG. 12 is generated as the display data for the head-mounted display based on the name information and the image information, and data that corresponds to the display example indicated by B1 in FIG. 12 is generated as the display data for the client apparatus based on the latitude information and the longitude information. Therefore, since related information can be displayed using a plurality of display sections (see FIG. 12), it is possible to compensate for the disadvantage (i.e., small screen) of the display section 120 of the client apparatus 100.

The processing section 210 may generate first display data for the head-mounted display to Nth display data for the head-mounted display and first display data for the client apparatus to Nth display data for the client apparatus based on data acquired from the external server system 400. When the ith display data for the head-mounted display and the ith display data for the client apparatus are related data, the display section 220 sequentially displays the first display data for the head-mounted display to the Nth display data for the head-mounted display at given display intervals, and the communication section 230 transmits the ith display data for the client apparatus to the client apparatus 100 when the ith display data for the head-mounted display is displayed on the display section 220.

This makes it possible to implement the steps S210 to S215 shown in FIG. 8. Specifically, when a plurality of pieces of data have been received at one time (see FIG. 11), the first data to the Nth data may be automatically and sequentially displayed at given display intervals. In this case, the image displayed on the head-mounted display 200 and the image displayed on the client apparatus 100 must be related information (e.g., information about an identical restaurant when the application is a gourmet application). Therefore, the communication section 230 of the head-mounted display 200 must transmit the display data for the client apparatus that relates to the display data for the head-mounted display that is currently displayed on the display section 220 to the client apparatus.

The communication section 230 of the head-mounted display 200 may transmit the display data for the client apparatus as the HTTP response to the HTTP request when the client apparatus 100 has transmitted the parameter for executing the application as the HTTP request.

This makes it possible to reliably link the HTTP request and the HTTP response. The HTTP request and the HTTP response basically make a pair. In the second embodiment, transmission of the parameter and transmission of the display data for the client apparatus make a pair.

The template storage section 240 may store a template of the application executed by the head-mounted display 200. The communication section 230 may receive the parameter for executing the application that has been set using the operation screen displayed on the display section 120 of the client apparatus 100. The processing section 210 may generate the application by embedding the parameter received by the communication section 230 in the template of the application.

This makes it possible to simplify the application generation process by utilizing the template. The application is written in JavaScript or the like (see FIGS. 10A and 10B), and is generated by replacing the tag (e.g., {{SORT}}) with the parameter. Specifically, the template storage section 240 according to the second embodiment stores the template for executing the application in addition to the template of the operation screen information described above in connection with the first embodiment.

The first and second embodiments according to the invention have been described above. Note that the invention is not limited to the first and second embodiments. Various modifications and variations may be made of the elements without departing from the scope of the invention. A plurality of elements of each of the first and second embodiments may be appropriately combined. For example, some of the elements described above in connection with the first and second embodiments may be omitted. The elements described in connection with different embodiments may be appropriately combined. Specifically, various modifications and applications are possible without materially departing from the novel teachings and advantages of the invention.

What is claimed is:

1. A head-mounted display comprising:
a display section that displays a display image;
a communication section that communicates with a client apparatus and an external server system; and
a processing section,
the communication section receiving a Hypertext Transfer Protocol (HTTP) request when the client apparatus has displayed an operation screen used to operate the head-mounted display on a display section of the client apparatus, and transmitted the HTTP request to the head-mounted display based on an operation performed using the operation screen displayed on the display section of the client apparatus,
the processing section executing a command that corresponds to the HTTP request received by the communication section, and
the communication section transmitting an execution result of the command executed by the processing section to the client apparatus as an HTTP response.

2. The head-mounted display as defined in claim 1,
the communication section receiving the HTTP request that includes a parameter for executing an application when the operation screen has been displayed on the display section of the client apparatus, and the parameter has been set using the operation screen, and
the processing section executing the application in which the parameter has been set based on the parameter.

3. The head-mounted display as defined in claim 2,
the processing section generating display data for the head-mounted display and display data for the client apparatus based on data acquired from the external server system via the communication section by executing the application,
the display section displaying the display image based on the display data for the head-mounted display, and
the communication section transmitting the display data for the client apparatus to the client apparatus as the HTTP response.

4. The head-mounted display as defined in claim 3,
the processing section generating first display data for the head-mounted display to Nth (N is an integer) display data for the head-mounted display and first display data for the client apparatus to Nth display data for the client apparatus based on the data acquired from the external server system,
the display section sequentially displaying the first display data for the head-mounted display to the Nth display data for the head-mounted display at given display intervals when ith (i is an integer that satisfies a relationship “1≦i≦N”) display data for the head-mounted display among the first display data for the head-mounted display to the Nth display data for the head-mounted display and ith display data for the client apparatus among the first display data for the client apparatus to the Nth display data for the client apparatus are related data, and
the communication section transmitting the ith display data for the client apparatus to the client apparatus when the ith display data for the head-mounted display is displayed on the display section.

5. The head-mounted display as defined in claim 3,
the communication section transmitting the display data for the client apparatus to the client apparatus as the HTTP response that corresponds to the HTTP request when the client apparatus has transmitted the parameter for executing the application as the HTTP request.

6. The head-mounted display as defined in claim 1,
the communication section accessing contents that correspond to a given uniform resource locator (URL), and receiving the contents when the HTTP request from the client apparatus is an instruction to display the contents that correspond to the given URL, and
the display section displaying the contents received by the communication section.

7. The head-mounted display as defined in claim 1,
the processing section executing the command based on the HTTP request from the client apparatus when the HTTP request is at least one command among a command to move a cursor within the display image, a command to select contents designated by the cursor, and a command to return to a previous screen, and
the display section updating the display image corresponding to the execution result of the command, and displaying the updated display image.

8. The head-mounted display as defined in claim 1, further comprising:
a template storage section that stores a template of operation screen information, the operation screen information being information for displaying the operation screen on the display section of the client apparatus,
the processing section generating the operation screen information by embedding address information about the head-mounted display in the template of the operation screen information that is stored in the template storage section.

9. The head-mounted display as defined in claim 8,
the template storage section storing a template of an application executed by the head-mounted display,
the communication section receiving a parameter for executing the application that has been set using the operation screen displayed on the display section of the client apparatus, and
the processing section generating the application executed by the head-mounted display by embedding the parameter received by the communication section in the template of the application that is stored in the template storage section.

10. The head-mounted display as defined in claim 1,
the processing section generating operation screen information when the communication section has received an initial connection request as the HTTP request from the client apparatus, the operation screen information being information for displaying the operation screen on the display section of the client apparatus, and
the communication section transmitting the operation screen information that has been generated by the processing section to the client apparatus as the HTTP response.

11. The head-mounted display as defined in claim 10,
the display section displaying address information about the head-mounted display as the display image,
the communication section receiving a request from the client apparatus that has been issued using a web browser based on the address information displayed on the display section as the initial connection request,
the processing section generating the operation screen information, and
the communication section transmitting the operation screen information that has been generated by the processing section to the client apparatus as the HTTP response.

12. The head-mounted display as defined in claim 1,
the communication section receiving screen information written in Hypertext Markup Language (HTML) from the client apparatus as the HTTP request, and
the display section displaying the display image that has been generated based on the screen information written in HTML that has been received by the communication section.

13. A client apparatus comprising:
a display section that displays a display image;
a communication section that communicates with another client apparatus and an external server system; and
a processing section,
the communication section receiving a Hypertext Transfer Protocol (HTTP) request when an operation screen used to operate the client apparatus has been displayed on a display section of the other client apparatus, and the HTTP request has been transmitted to the client apparatus from the other client apparatus based on an operation performed using the operation screen displayed on the display section of the other client apparatus,
the processing section executing a command that corresponds to the HTTP request received by the communication section, and
the communication section transmitting an execution result of the command executed by the processing section to the other client apparatus as an HTTP response.
